(19) United States
(12) Patent Application Publication
(10) Pub. No.: US 2011/0159208 A1
(43) Pub. Date: Jun. 30, 2011

(54) IMPROVEMENTS IN THE MANUFACTURE OF B-STAGE RESIN IMPREGNATED PAPERS OR NON-WOVENS

(75) Inventor: David Elwyn Price, Victoria (AU)

(73) Assignee: Depco-TRH Pty Ltd, Williamstown, Victoria (AU)

(21) Appl. No.: 12/599,282

(22) PCT Filed: May 7, 2008
(86) PCT No.: PCT/AU2008/000638

§ 371 Date: Nov. 6, 2009

(30) Foreign Application Priority Data
May 7, 2007 (AU) 2007902387
May 7, 2007 (AU) 2007902390
Jun. 13, 2007 (AU) 2007903171
Oct. 29, 2007 (AU) 2007905921
Nov. 2, 2007 (AU) 2007906095

(51) Int. Cl. B05D 3/06; B05C 9/08

(52) U.S. Cl. 427/557; 118/642

(57) ABSTRACT

A method of manufacturing a b-stage resin impregnated décor paper that is suitable for inclusion in a decorative or industrial laminate, includes impregnating a décor print base paper with a resin carried by a solvent, which resin includes one or more of melamine formaldehyde, urea formaldehyde, and phenol formaldehyde or any combination of these. Thereafter the resin impregnated paper is irradiated with near infra-red (NIR) radiation selected to partially remove solvent by evaporation of the solvent, whereby to produce a partially dried and partially cured printable b-stage resin impregnated paper. The partially dried and partially cured printable b-stage resin impregnated paper is then printed to obtain a décor paper suitable for subsequent final curing in the formation of a decorative or industrial laminate. Apparatus is also disclosed, as is a method that entails impregnating a paper with an aqueous urea solution and irradiating the wet impregnated paper with near infra-red (NIR) radiation.

### FIELD OF THE INVENTION

The invention relates to the manufacture of partially cured resin impregnated papers or non-wovens suitable for use in decorative and industrial laminates.

The impregnated and optionally coated paper or non-woven, known as a b-stage impregnated paper, is subsequently fully cured under pressure in a hot press to form a laminate. The full and final curing of the laminate in a hot press while under pressure enables the b-stage impregnated paper to bond with other b-staged papers, and/or a carrier substrate such as particleboard, fibreboard or oriented strand board.

The invention therefore also relates to laminate products manufactured using the partially cured resin impregnated papers or non-wovens formed according to the invention.

Any reference herein to a prior document or other prior disclosure is not to be taken as an admission that the content of the document or the disclosure is common general knowledge, either in Australia or elsewhere.

### BACKGROUND OF THE INVENTION

The optimal process technology for bringing impregnated papers or non-woven materials used in laminate manufacture to the so-called b-stage includes all of single bath, single bath and coating, and single bath and multiple coating options. “Single bath” also embraces multiple dipping in a single bath or split baths. Papers or non-wovens may be developed that only require coating of the resin onto a pretreated surface thereby avoiding the usual first bath saturation.

The basic option is to saturate the paper or non-woven in a bath of resin, usually urea formaldehyde (UF) resin, melamine formaldehyde (MF) resin, phenol formaldehyde (PF) resin or any combination of these, before controlling the resin pick-up via a set of metering rollers. The resin impregnated paper or non-woven is then passed through a set of ovens, each oven or zone set at temperatures that enable the solvent to volatilise and the resin to progress in the degree of cure. The rate of progress of the paper or non-woven through the oven, and the temperature profile, can be carefully controlled to prevent premature skinning of the surface through resin polymerisation in the outer layer. If this occurs, remaining internal water has to force itself out through the skinned film which causes a problem with dusting arising from broken off particles of dried resin, and in some cases also filler particles. This is avoided by having a graduated drying profile over significant drying oven length—the productivity comes from line speed which is limited by the number of drying ovens and their temperatures.

It is important to avoid the dusting effect because this would present a significant occupational health and safety issue. Dusting can cover parts of equipment such as safety beams used as breakers if a worker enters a dangerous part of the machine, and a health issue inevitably arises from dust particles in the air.

The impregnated paper or non-woven at the end of the impregnation process has a known amount of remaining volatiles and a known degree of cure. This partially dried and partially cured impregnated paper or non-woven is known as a b-stage impregnated paper.

Among further options in the impregnation process to achieving the desired b-stage impregnated paper, there is the option to further coat the impregnated paper or non-woven before any partial drying and partial curing takes place, so-called wet-on-wet processing, before partial drying and partial curing in a set of heated ovens, whether gas fired, oil fired or heated by other means.

The state of the art is not limited to the abovementioned descriptions, as one skilled in the art would know. Numerous combinations of resin types, resin content, resin additives, additives for specific purposes, such as corundum for improved abrasion resistance, and remaining volatiles and degree of cure are preferred for different strategies in producing the final laminate.

There are several aspects in the current method of manufacturing b-stage impregnated papers that are economically disadvantageous. First is the high cost of energy arising from the set of ovens. Second is the large footprint in the form of the long series of drying ovens required to achieve high operating speed. Third is that the gas fired or oil fired drying ovens are always used at maximum operating width, a disadvantage when treating a paper or non-woven at a web width less than the maximum of the drying oven.

It has been proposed in applicant's international patent publication WO2007/065222 that NIR irradiation can be usefully applied to the production of pre-pregs. The skinning and consequent dusting problems that might have been expected to arise with the higher drying rates that can be achieved with NIR irradiation do not arise because NIR radiation does not rely on thermal conduction to the interior as do conventional ovens and infra-red heating systems, but is directed immediately into the whole body of the wet resin to achieve substantially instantaneous drying. The NIR radiation is thought to cause flash evaporation of the solvent, which is most often water, by agitation of the solvent molecules, NIR irradiation allows substantially uniform application of the NIR radiation through the impregnated paper or non-woven, an outcome not possible in current state of the art drying equipment. The energy can be applied across the width of the web rather than the width of the drying cabinet.

NIR irradiation allows a considerable reduction in the number of drying ovens required to achieve the desired properties of the partially dried and partially cured b-stage impregnated paper. NIR irradiation may be employed alone or in conjunction with conventional non-NIR drying/curing ovens to achieve a pre-determined drying program.

It is an object of the invention to derive from the use of NIR irradiation one or more further process or product improvements.

### SUMMARY OF THE INVENTION

In a first aspect, the invention relates to the case where the b-stage resin impregnated paper is a décor print base paper. For the manufacture of printed decorative laminates, substrates, for example decorative paper, are usually printed and subsequently impregnated, usually with amino-formaldehyde type resin or resins in which the paper materials serve as a carrier for the pre-polymer a-stage resin starting material as well as for the printed design. This prior practice must deal with the issue of expansion of the printed paper during the impregnation process. Impregnation after the printing step is necessary due to the brittleness and stickiness of the b-stage saturated, or saturated and coated, impregnated paper. The need to know and have a repeatable paper expansion value has led to significant advances in the papermaking process and measurement of the paper expansion, however the problem of matching paper expansion to the texture of the press tool remains.

Typically the printed paper, after impregnation and curing to the desired b-stage, is laid onto a substrate, for example an impregnated kraft paper or plurality of impregnated kraft papers usually impregnated with PF resin, or particleboard or a fibreboard (eg., MDF or HDF), and bonded to the substrate in a hot press where the partially cured resin flows and cures from its b-stage to its final state, called the c-stage.

It has been discovered according to the first aspect of the invention that an advantage over the prior art in the method of manufacturing a printed decorative laminate that requires resin flow in the pressing step, is to impregnate the décor print base paper to the desired degree with an amino-formaldehyde or phenol formaldehyde resin, and to subsequently dehydrate the impregnated printed paper by vapourising the water without substantially growing the size of the polymeric resin. This is preferably achieved by NIR irradiation.

The invention therefore provides, in its first aspect, a method of manufacturing a b-stage resin impregnated décor paper that is suitable for inclusion in a decorative or industrial laminate, characterised by impregnating a décor paper with a resin carried by a solvent, which resin includes one or more of melamine formaldehyde, urea formaldehyde, and phenol formaldehyde or any combination of these, thereafter irradiating the resin impregnated paper with near infra-red (NIR) radiation selected to partially remove solvent by evaporation of the solvent, whereby to produce a partially dried and partially cured printable b-stage resin impregnated paper, and then printing the partially dried and partially cured printable b-stage resin impregnated paper to obtain a décor paper suitable for subsequent final curing in the formation of a decorative or industrial laminate.

The invention also provides, in its first aspect, a method of manufacturing a b-stage resin impregnated décor paper that is suitable for inclusion in a decorative or industrial laminate, characterised by impregnating a décor paper with a resin carried by a solvent, which resin includes one or more of melamine formaldehyde, urea formaldehyde, and phenol formaldehyde or any combination of these, thereafter vapourising the solvent without substantially growing the size of the polymeric resin derived from said impregnating resin, whereby to produce a partially dried and partially cured printable b-stage resin impregnated paper, and then printing the partially dried and partially cured printable b-stage resin impregnated paper to obtain a décor paper suitable for subsequent final curing in the formation of a decorative or industrial laminate.

In its first aspect, the invention still further provides apparatus for manufacturing a b-stage resin impregnated décor paper that is suitable for inclusion in a decorative or industrial laminate, including a resin impregnation station for impregnating a décor paper with resin carried by a solvent, which resin includes one or more of melamine formaldehyde, urea formaldehyde and phenol formaldehyde or any combination of these, irradiation means to irradiate the resin-impregnated paper with near infra-red (NIR) radiation to partially remove solvent by evaporation of the solvent, whereby to produce a partially dried and partially cured printable b-stage resin impregnated paper, and, downstream of the irradiation means, a printing station for printing the partially dried and partially cured printable b-stage resin impregnated paper to obtain a décor paper suitable for subsequent final curing in the formation of a decorative or industrial laminate.

By “near infra-red” is herein meant the wavelength range between the visible region and 2.5 μm, ie about 0.7 to 2.5 μm.

In one application, the décor paper that is impregnated is a décor print base paper.

Preferably, the partially dried and partially cured printable b-stage resin impregnated paper has no more than 15% w/w volatiles, more preferably no more than 10% w/w volatiles, still more preferably in the range 4 to 10% w/w volatiles, most preferably 4-8% w/w volatiles. The residual volatile content, which will typically be mainly water, is preferably such as not to create a hydrophobic surface for any subsequent coating step. Such a surface can cause resin to be missing over parts of a subsequent coat. The 4 to 10% content in the core impregnation is a lower figure than is conventional (10 to 15%), but still allows resin flow in downstream pressing—this in turn can mean better pressing times and a better laminate surface.

Preferably, said NIR irradiation is such that a substantial proportion of the solvent is evaporated from the resin impregnated paper, but curing of the resin is limited to an extent whereby said partially dried and partially cured b-stage resin impregnated paper is printable.

Advantageously, said NIR irradiation is such that there is proportionately greater removal of solvent than there is curing of the resin, to an extent required for the partially dried and partially cured b-stage resin impregnated paper to be printable.

The NIR radiation is preferably applied substantially uniformly through the resin impregnated paper.

The paper may typically be an elongated web conveyed through a heating and curing station at which said irradiation is effected.

The resin-impregnated paper is irradiated with NIR radiation, to produce the partially dried and partially cured b-stage resin impregnated paper, for a time period preferably no more than 60 seconds, more preferably less than 5 seconds.

After printing of the impregnated décor paper, the printed décor paper may be further coated to increase the total amount of amino type resin, or may be laminated together with a substrate and with a resin impregnated protective overlay.

Unlike other known radiation technologies such IR curing, NIR irradiation is able to vaporize the water throughout the body of the impregnated paper at high line speed without overly heating the resin itself. Unlike IR or hot air, which work from the outer surface towards the centre and in doing so start to form a barrier through which the remaining moisture must dissipate, the NIR radiation causes substantially immediate vaporisation of the water throughout the body of the impregnated paper without forming a barrier through which the water must dissipate.

In an embodiment according to the first aspect of the invention an amino-formaldehyde resin, usually melamine formaldehyde resin or urea formaldehyde resin or melamine urea formaldehyde resin or mixtures thereof including appropriate additives such as but not limited to wetting agent, release agent, plasticizer, catalyst is in the first stage used to saturate the core of the décor print base paper after which a set of metering rolls are used to control the resin pick-up before passing the first stage impregnated décor print base paper through an NIR dehydration station. After the NIR station or NIR stations it may be advantageous to calender the partially dried and partially cured printable b-stage resin impregnated paper to increase or enhance smoothness, for subsequent printing and/or subsequent coating, followed by cooling the impregnated paper before rewinding. In particular, it is practical that the paper may be printed in-line following the impregnation and drying steps, either before or after calendering. It is also practical that the paper may be further coated and cured in-line following the impregnation, drying and calendering steps. Such a coating may be applied over a printed paper, or printing may be onto the coating. The coating may be a primer or adhesion promoter and a lacquer.

In a particular aspect, the invention includes impregnating a décor paper with resin as aforedescribed, dehydrating the impregnated paper by irradiation with NIR radiation, calendaring the impregnated and at least partially dried paper to increase smoothness, and then applying a further resin coating.

By using the method according to the first aspect of the invention, a dimensionally stable pre-impregnated print base paper is able to provide a printing surface that substantially avoids the problems incurred in the manufacture of registered embossed laminates. The art of registered embossed laminates is a manufacturing method to align the printed surface with the structural embossing applied by textured pressplates. The co-efficient of expansion of the stainless steel pressplates is well known, the irregularity of expansion with décor paper is also well known, so a process to avoid or substantially minimize the expansion of paper after the printing process is of great economic and aesthetic value.

In a particular embodiment, the décor paper is preferably impregnated with a melamine formaldehyde resin and partially dried using NIR irradiation to a moisture content of around 8%, in any case the amount of residual moisture and the degree of cure of the resin in the impregnated paper before printing should enable the resin to flow in the subsequent lamination process. Preferably the NIR irradiation is applied substantially from below the paper and most preferably with the décor side of the décor paper also on the lower side of the web. The décor paper printing surface may also be calendered or otherwise smoothened after impregnation to improve printability or to facilitate application of a further coating, as already discussed. Indeed, a coating may be applied before or after calendering.

Where printing is envisaged herein, it may be digital printing where appropriate. Coatings may also be applied by “digital” methods, e.g. with an “inkjet” device.

Due to the likely reel to reel nature of the process according to the invention the speed of the impregnation is only limited by the need to achieve proper first stage impregnation and drying and not by the limited ability of the crosscutter to cut and stack sheets at any given speed. The use of the NIR avoids the build-up of a resin skin on the surface of the pre-impregnated paper as well as providing a drying method that requires substantially less space for the equipment than prior art.

The décor print base paper usually has a grammage between 35 g/m² and 200 g/m2. The amount of resin used to impregnate the core of the décor paper is controlled to avoid any stickiness and is usually less than 100% of the paper weight, preferably less than 80% and most preferably approximately 60% of the base paper weight. Still lower resin amounts can be applied in the first stage impregnation and the optimal resin quantity will vary with the paper specification and because of the knowledge that it is possible to manipulate the total resin content of the final b-stage paper through the ability to coat various amounts of resin after the printing process or with a clear overlaying paper also impregnated with resin.

The further curing of the impregnated, printed and coated décor paper can be by heat, or irradiation to reach the desired volatile content in the so-called b-stage product.

In a second aspect of the invention, it has been realized that NIR irradiation can be usefully applied to a paper impregnated with an aqueous urea solution.

In the prior art of manufacturing impregnated décor papers it was common to have only a single bath for holding the impregnating resin and to fully impregnate the décor paper in one step, or at least with only one resin, usually melamine formaldehyde resin. It was later established that partial drying of the first bath-impregnated décor paper would allow a second resin, either chemically the same or different, to be applied and today this is known as a split oven configuration. This enabled the use of a less expensive core impregnation with urea formaldehyde resin or melamine modified urea formaldehyde resin, however to avoid the sheets or rolls containing UF resin in the core from sticking together and to provide an active resin layer for adhesion to the woodpanel substrate as well as a fully closed surface of the laminate, the subsequent coating is a melamine formaldehyde resin on both sides of the paper. This may be an asymmetric coating. This coating with MF on both sides is also necessary if the paper will be pressed without regard to A-side or B-side up as is the case with an inexpensive white paper. However printed papers are usually printed only on one side, and unicolour papers usually have a distinguishable décor side and wire side, the décor side being somewhat darker in appearance. Therefore there would be a significant economic advantage if only the press-side of the impregnated décor paper was coated with ME resin, while the core and board-side contained a urea formulation, for example UF resin.

The second aspect of the invention addresses this object by providing a method of manufacturing a b-stage resin impregnated paper that is suitable for inclusion in a decorative or industrial laminate, characterised by impregnating a paper with an aqueous urea solution to produce a wet impregnated paper and thereafter irradiating the wet impregnated paper with near infra-red (NIR) radiation selected whereby the wet impregnated paper is substantially dehydrated but crosslinking of the urea solution components is not substantially advanced, so as to produce a highly flexible dry-to-touch b-stage impregnated paper that is stackable and or reelable and is suitable for subsequent final curing in the formation of a decorative or industrial laminate.

The highly flexible dry-to-touch impregnated paper or non-woven may be subjected to one or more treatments of a set of further treatments consisting of coating the décor side only with a layer of resin or a print receptive coating, preferably an inkjet ink receptive coating, and or calendering the impregnated or impregnated and coated paper to increase smoothness, and or applying printing and optimally coating the printed side, and or further processing involving adhering the paper or non-woven to a substrate optionally with an amino resin impregnated overlay in a hot press.

The paper or non-woven impregnated with the urea solution and NIR treated can be loosely adhered to a substrate, for example a woodpanel such as particleboard or fibreboard, and the surface of the paper or non-woven printed whether by ink jet printing or any other printing method. The means for loosely adhering the NIR treated paper or non-woven can be any convenient method for example by ultrasonic welding.

Alternatively the paper or non-woven impregnated with the urea solution preferably containing formaldehyde and dried with NIR radiation can be without further treatment pressed on to a woodpanel substrate using heat and pressure and in a later step the porous urea rich surface is coated or lacquered to provide a non porous surface. Non-limiting examples of the coating or lacquer are acrylic, epoxy, urethane, melamine or polyester type polymers or any combination thereof, in any case to provide a hard non porous surface layer. The urea rich surface may be printed before the coating or lacquer is applied. The coating or lacquer may contain additives to provide additional benefits such as but not limited to improved abrasion resistance, an antistatic surface, an antibacterial surface, an improved light stability or any combination of these.

The “aqueous urea solution” preferably comprises an aqueous solution containing one or more or any combination of (i) urea in water, (ii) urea and formaldehyde in water (iii) urea formaldehyde resin in water, (iv) melamine modified urea formaldehyde in water and (v) phenol modified urea formaldehyde in water. More preferably, the aqueous urea solution contains urea and formaldehyde, and/or urea formaldehyde resin. In general, the urea may be a distinct species in solution, or present in combination with another component, or in a compound with another component.

The further treatment that comprises a coating with a layer of resin preferably entails a layer of melamine formaldehyde (MF) resin.

The impregnating solution is preferably about 50% w/w water and the substantial dehydration of the impregnated paper or impregnated non-woven preferably results in a paper that has less than 20% w/w volatiles, more preferably less than 15% w/w volatiles, most preferably less than 10% w/w volatiles. The residual volatile range is chosen to enable the selected further treatment(s) to be compatible with the first impregnation in aqueous solution, being a choice between but not limited to printing the impregnated paper, applying a coating to one side of the paper or using the paper without a further coating being applied. If further coated this is possible by various methods not limited to one side gravure roll coating, curtain coating or any other practical method.

The highly flexible dry-to touch impregnated paper may be dry coated on one side with a melamine monomer, melamine dimer or melamine trimer by means of vapour deposition or, with the aforementioned melamine sources, or a substantially dry melamine formaldehyde resin by means of electrostatic powder coating. Suitable such methods are disclosed in, for example, applicant's international patent publication WO2006/130907 and in the applicant's granted European patent EP1595718. The melamine rich surface may be calendered to improve smoothness.

Downstream of the irradiation, in either aspect of the invention, the subsequent b-stage impregnated paper may be employed in a process of manufacturing a decorative or industrial laminate from one or more of the b-stage impregnated papers. Indeed, the invention extends to a method of manufacturing a decorative laminate, characterised by employing one or more b-stage impregnated papers or non-wovens produced in a method according to the first or second aspect of the invention. Optionally, this method may further employ in the laminate one or more b-stage impregnated papers or non-wovens produced by drying and curing in conventional non-NIR ovens. The final fully cured surface and surface characteristics may be obtained, for example, in a hot press.

In all aspects of the invention, the method may include applying a lacquer to the b-stage impregnated paper before or after pressing in a hot press. The lacquer may contain one or more of abrasion resistant particles, particles that improve scratch resistance, light stabilisers, anti-static additives and anti-bacterial additives. The lacquer may be applied to one or more surfaces of the laminate including the b-stage paper as the surface layer. In the apparatus, there may be means to apply a lacquer to the b-stage impregnated paper, b-stage impregnated printed paper, or to a laminate including the b-stage impregnated paper as the surface layer.

### BRIEF DESCRIPTION OF THE DRAWINGS

The invention will now be described, by way of example only, with reference to the accompanying drawings, in which:

FIG. 1 is a schematic depiction of apparatus for manufacturing a b-stage pre-preg of resin impregnated paper or non-woven, according to an embodiment of the invention; and

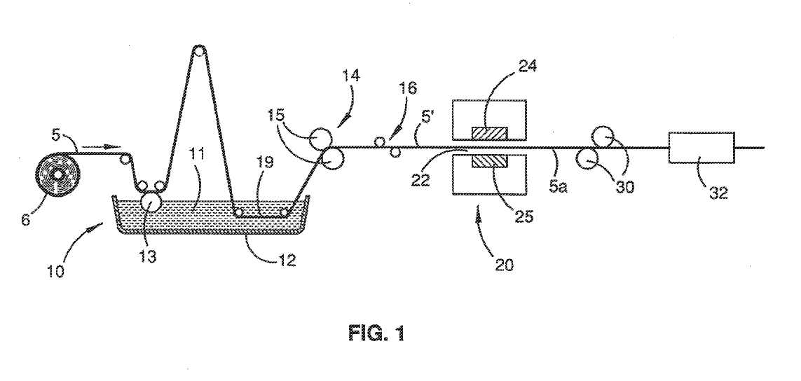

FIG. 2 is a diagrammatic plan view of one of the NIR irradiator units.

### EMBODIMENTS OF THE APPARATUS

The illustrated apparatus includes a resin impregnation station 10, and an irradiation station 20. An elongated web 5 of paper or non-woven is drawn from a roll 6 through the successive stations 10, 20. This may typically be a décor paper, and, in particular applications, a décor print base paper.

Resin impregnation station 10 comprises an aqueous or other solvent resin bath 12 in which web 5 is in contact twice with the resin 11 as illustrated to ensure paper saturation, a short contact against a pre-wet roll 13, followed by a longer dip 19. Web 5 then passes to metering means 14 comprising metering rollers 15 that are adjustable to control the amount of resin outside the body or matrix of the paper or non-woven web 5. It is found that best results are achieved downstream if the metering means is set to substantially remove resin outside the body or matrix of the paper and non-woven, i.e. there is left at most only a minimal surface coating of the resin on the paper or non-woven.

For the first aspect of the invention, the resin is typically melamine formaldehyde (MF), urea formaldehyde (UF) or phenol formaldehyde (PF) resin, but these may be used in combination, or any other suitable or desired resin may be employed. For the second aspect of the invention, the bath is more specifically an aqueous urea solution, as earlier described.

Downstream of metering rolls 15 the impregnated paper or non-woven 5′ optionally contacts a set of smoothing rolls 16 and is then passed into a treatment tunnel 22 of irradiation station 20. Here, the impregnated paper or non-woven 5′ is irradiated from both sides by respective NIR irradiator units 24, 25 for a period typically in the range 0.2 to 1.5 seconds. This irradiation is effective to substantially remove the resin solvent, typically water, by flash evaporation of the solvent, effected through agitation of the solvent molecules. The degree of polymerisation of the resin is not significantly affected by the NIR radiation, and in general it is desirable to limit this degree of polymerisation during and immediately following the irradiation. The web that emerges from irradiation station 20 is a partially dried partially cured printable b-stage resin impregnated paper 5a. The volatile content is preferably in the range 4 to 8%, as earlier discussed.

The web 5 is moved through the successive units by a web conveying configuration of suitable form. This is not illustrated in detail but components are depicted diagrammatically at some turning points, e.g. at 17.

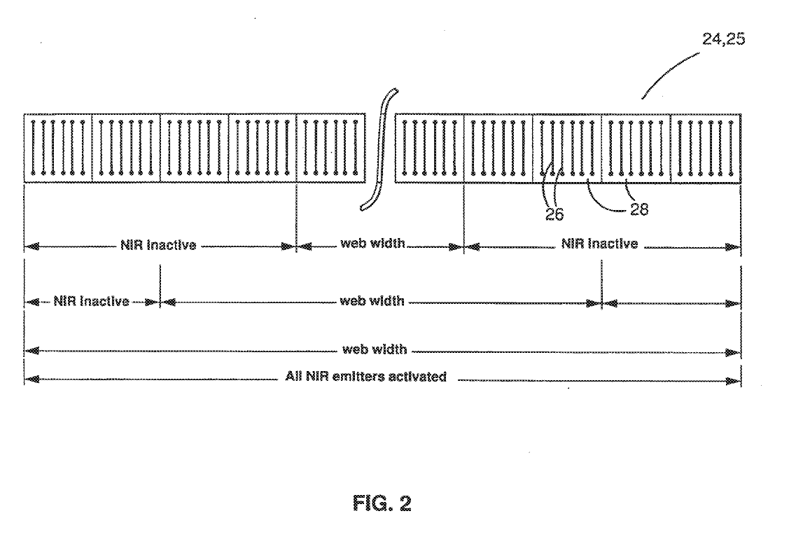

Each NIR irradiator unit 24, 25 conveniently comprises a bank of elongate NIR emitters 26 (FIG. 2) preferably arranged in functional blocks 28 of six emitters each. The bank extends as an upper or lower bridge across the web path with the emitters aligned in the direction of web travel. Each block may, for example, extend 120 mm laterally of the web, with each emitter, e.g., 250 mm long. With this arrangement, the NIR emitter 26, or at least the emitter blocks 28, that lie outside the impregnated web of paper or non-woven can be turned off, meaning that the radiation is only applied on the web and not significantly outside the web, thereby increasing energy productivity. Examples of different web widths are annotated in FIG. 2.

The distance from the web to the emitters 26 is adjustable according to other parameters such as type of emitter, web speed and grammage or colour of the paper or non-woven material.

In a modified embodiment successive NIR irradiations are effected, either with separate irradiators in the one unit or at separate spaced irradiation stations.

In the preferred practice of at least the first aspect of the invention, the paper 5a is treated by calendering rolls 30 to improve the smoothness of the paper and enhance its suitability for printing. The calendered paper may then be temporarily reeled up for later printing, or is passed directly to a printing station 32 where it is directly printed by any suitable method.

Analytical results from preferred urea formaldehyde formulations present within treated papers prepared with the illustrated apparatus in accordance with a second aspect of the invention have demonstrated the presence of free formaldehyde, free urea, monomethylol urea, dimethylol urea, low molecular weight UF oligomers and other UF resin components. These papers appear dry and flexible, they are smooth and silk to touch, and the papers can be sheet stacked or reeled without fear of blocking as they are not hygroscopic.

One possible explanation, not posited as a binding disclosure herein, for the observed properties of the flexible dry-to-touch impregnated paper or non-woven prepared from an aqueous urea solution is that the NIR drying and curing effectively removes water with little resin polymerisation. Most of the physical water is rapidly removed by the specific NIR frequencies without much increase in temperature. It is further thought that while the electromagnetic radiation simultaneously dehydrates the water used as the solvent for impregnating solution, due to the short dwell time at the electromagnetic device and the low temperatures only limited polymerisation is able to occur. The resin remains as a narrow band of polymer molecular weights and it is this narrow range of molecular weights that contributes to the special properties found with these treated and NIR dried and cured papers.

It is known that urea, and separately formaldehyde, will react with cellulose when the cellulose has been pre-treated with an alkali under carefully controlled conditions. Where formaldehyde is present, the electromagnetic radiation may possibly be providing an energy source to cause the urea and formaldehyde to react whereby to form urea formaldehyde derivatives with polyoxymethylene linkages that are interacting with the cellulose in the paper or non-woven without the need to pre-treat the cellulose with an alkali. This is thought to be predominately hydrogen bonding rather than crosslinking reaction as it has been shown in a subsequent procedure that substantially all of the urea and formaldehyde can be removed from the impregnated paper by simply rubbing the impregnated paper while in warm water.

Where acid catalyst is used in the UF resin to advance cure of the resin, this catalyst may in fact be assisting in the reaction between the cellulose and the other components of the impregnating solution.

When using UF resin as the impregnating agent there is free formaldehyde and urea available in the resin. Also upon application of electromagnetic radiation, further formaldehyde and urea can be released by the energy provided by the radiation which may cause some dissociation of urea and formaldehyde in the resin.

Where the aqueous urea solution contains urea and formaldehyde or urea formaldehyde resin, the impregnated paper or non-woven containing urea, formaldehyde, and various UF resin derivatives such as monomethylol urea or dimethylol urea or polyoxymethylene urea may be subsequently used in the manufacture of a decorative laminate, whether as an impregnated paper below a protective overlay that is impregnated with MF resin, or solely as an impregnated paper or non-woven further coated on the upper side (press tool side) with, an MF resin. It is well known in the art of impregnated papers for decorative laminates that the overlay or the MF resin may contain hard particles such as corundum to improve abrasion resistance.

### Example 1

A 70 g/m² white décor paper was impregnated with urea formaldehyde resin. The UF resin was 50% by weight water to which was added a wetting agent, a release agent and a catalyst in amounts respectively as % by weight on wet resin of 0.3% wetting agent, 0.2% release agent and 0.2% catalyst. The primary component of the catalyst was PTSA. The gel time of the UF resin was 220 seconds.

The impregnated paper was passed through an electromagnetic field created using NIR emitters of 1800 Watt at 90% power at a line speed of 10.7 m/min.

The weight of the paper after impregnation including volatile components was 118.3 g/m².

The weight of the bone dry paper was 68 g/m² and the weight of the paper and resin was measured as 108.9 g/m² bone dry (bone dry referring to the weight after drying a sample in a hot oven with circulating air at 160 C for 5 minutes). Volatile content is therefore calculated as 7.95%

### Example 2

A beige print base paper was impregnated using the same UF resin as in example 1.

The impregnated paper was passed through an electromagnetic field created using NIR emitters of 1800 Watt at 50% power at a line speed of 112 m/min.

The weight of the paper after impregnation including volatile components was 122.5 g/m².

The weight of the bone dry paper was 70.2 g/m² and the weight of the paper and resin was measured as 112.1 g/m² bone dry. Volatile content is therefore calculated as 8.49%.

Analytical results from urea formaldehyde formulations extracted from the treated papers prepared in accordance with examples 1 and 2 indicated the presence of free formaldehyde, free urea, monomethylol urea, dimethylol urea, low molecular weight UF oligomers and other UF resin components. The papers appeared dry and flexible, were dry, smooth and silk to touch, and were not hygroscopic. By virtue of this latter property, the papers could be sheet stacked or reeled without fear of blocking.

1. A method of manufacturing a b-stage resin impregnated décor paper that is suitable for inclusion in a decorative or industrial laminate, characterised by impregnating a décor paper with a resin carried by a solvent, which rein includes one or more of melamine formaldehyde, urea formaldehyde, and phenol formaldehyde or any combination of these, thereafter irradiating the resin impregnated paper with near infra-red (NIR) radiation selected to partially remove solvent by evaporation of the solvent, whereby to produce a partially dried and partially cured printable b-stage resin impregnated paper, and then printing the partially dried and partially cured printable b-stage resin impregnated paper to obtain a décor paper suitable for subsequent final curing in the formation of a decorative or industrial laminate.

2. A method according to claim 1 wherein said NIR irradiation is such that a substantial proportion of the solvent is evaporated from the resin impregnated paper, but curing of the resin is limited to an extent whereby said partially dried and partially cured b-stage resin impregnated paper is printable.

3. A method according to claim 1 wherein said NIR irradiation is such that there is proportionately greater removal of solvent than there is curing of the resin, to an extent required for the partially dried and partially cured b-stage resin impregnated paper to be printable.

4. A method according to claim 1, 2 or 3 wherein said partially dried and partially cured b-stage resin impregnated paper has no more than 15% w/w volatiles.

5. A method according to claim 4 wherein said partially dried and partially cured b-stage resin impregnated paper has volatiles in the range 4 to 10% w/w.

6. A method according to any one of claims 1 to 5 wherein the NIR radiation is applied substantially uniformly through the resin impregnated paper.

7. A method according to any one of claims 1 to 6 wherein said décor paper is an elongated web conveyed through a heating and curing station at which said irradiation is effected.

8. A method according to any one of claims 1 to 7 further including, before said printing step, calendering the partially dried and partially cured printable b-stage resin impregnated paper, to enhance its smoothness for printing.

9. A method according to any one of claims 1 to 8 further including applying one or more successive thin coats before and/or after said printing step.

10. A method according to any one of claims 1 to 9 wherein said evaporation of the solvent is flash evaporation of the solvent by agitation of the solvent molecules.

11. A method according to any one of claims 1 to 10 wherein said resin-impregnated paper is irradiated with NIR radiation to produce the partially dried and partially cured b-stage resin impregnated paper, for a time period no more than 60 seconds.

12. A method according to any one of claims 1 to 10 wherein said resin-impregnated paper is irradiated with NIR radiation, to produce the partially dried and partially cured printable b-stage resin impregnated paper, for a time period less than 5 seconds.

13. A method of manufacturing a decorative or industrial laminate, characterised by employing one or more b-stage resin impregnated décor papers produced according to any one of claims 1 to 12.

14. A method according to claim 13 including fully curing the b-stage resin impregnated décor paper(s) in a hot press.

15. A method of manufacturing a b-stage resin impregnated paper that is suitable for inclusion in a decorative or industrial laminate, characterised by impregnating a paper with an aqueous urea solution to produce a wet impregnated paper and thereafter irradiating the wet impregnated paper with near infra-red (NIR) radiation selected whereby the wet impregnated paper is substantially dehydrated but crosslinking of the urea solution components is not substantially advanced, so as to produce a highly flexible dry-to-touch b-stage impregnated paper that is stackable and or reelable and is suitable for subsequent final curing in the formation of a decorative or industrial laminate.

16. A method according to claim 15 wherein said aqueous urea solution is an aqueous solution containing one or more or any combination of (i) urea in water, (ii) urea and formaldehyde in water (iii) urea formaldehyde resin in water, (iv) melamine modified urea formaldehyde in water and (v) phenol modified urea formaldehyde in water.

17. A method according to claim 15 where said aqueous urea solution contains urea and formaldehyde, and/or urea formaldehyde resin.

18. A method according to claim 15, 16 or 17 wherein said aqueous urea is about 50% water.

19. A method according to any one of claims 15 to 18 wherein the substantial dehydration of the impregnated paper or impregnated non-woven results in a highly flexible dry-to-touch b-stage impregnated paper that has less than 20% w/w volatiles.

20. A method according to any one of claims 15 to 18 wherein the substantial dehydration of the impregnated paper or impregnated non-woven results in a highly flexible dry-to-touch b-stage impregnated paper that has 4 to 10% w/w volatiles.

21. A method according to any one of claims 15 to 20 wherein said evaporation of the solvent is flash evaporation of the solvent by agitation of the solvent molecules.

22. A method according to any one of claims 15 to 21 wherein said NIR irradiation is for a time period less than 60 seconds.

23. A method according to any one of claims 15 to 21 wherein said NIR irradiation is for a time period less than 5 seconds.

24. A method of manufacturing a decorative or industrial laminate, characterised by employing one or more b-stage impregnated papers produced according to any one of claims 15 to 23.

25. A method according to claim 24 including fully curing the b-stage resin impregnated paper(s) in a hot press.

26. Apparatus for manufacturing a b-stage resin impregnated décor paper that is suitable for inclusion in a decorative or industrial laminate, including:
a resin impregnation station for impregnating a décor paper with resin carried by a solvent, which resin includes one or more of melamine formaldehyde, urea formaldehyde and phenol formaldehyde or any combination of these;
irradiation means to irradiate the resin-impregnated paper with near infra-red (NIR) radiation selected to partially remove solvent by evaporation of the solvent, whereby to produce a partially dried and partially cured printable b-stage resin impregnated paper; and
downstream of the irradiation means, a printing station for printing the partially dried and partially cured printable b-stage resin impregnated paper to obtain a décor paper suitable for subsequent final curing in the formation of a decorative or industrial laminate.

27. Apparatus according to claim 26 wherein said irradiation means is configured for applying the NIR radiation substantially uniformly through the impregnated paper.

28. Apparatus according to claim 26 or 27, further including means for conveying said paper as an elongated web through said resin impregnation station, said irradiation means and said printing station.

29. Apparatus according to claim 26, 27 or 28 further including calendaring means positioned for calendaring the partially dried and partially cured printable b-stage resin impregnated paper to enhance its smoothness for printing.

30. Apparatus according to any one of claims 26 to 29 further including means for applying one or more successive thin coats of resin either before or after said printing step.

31. Apparatus according to any one of claims 26 to 30 further including a hot press for fully curing the resin impregnated papers.

32. Apparatus according to any one of claims 26 to 31, further including means downstream of said irradiation means for applying one or more successive thin coats of resin to the partially dried and partially cured b-stage resin impregnated paper produced by the irradiation means.

33. A method of manufacturing a b-stage resin impregnated décor paper that is suitable for inclusion in a decorative or industrial laminate, characterised by impregnating a décor paper with a resin carried by a solvent, which resin includes one or more of melamine formaldehyde, urea formaldehyde, and phenol formaldehyde or any combination of these, thereafter vapourising the solvent without substantially growing the size of the polymeric resin derived from said impregnating resin, whereby to produce a partially dried and partially cured printable b-stage resin impregnated paper, and then printing the partially dried and partially cured printable b-stage resin impregnated paper to obtain a décor paper suitable for subsequent final curing in the formation of a decorative or industrial laminate.

34. A method according to claim 33 wherein said partially dried and partially cured b-stage resin impregnated paper has no more than 15% w/w volatiles.

35. A method according to claim 33 wherein said partially dried and partially cured b-stage resin impregnated paper has volatiles in the range 4 to 10% w/w.

36. A method according to any one of claim 32, 33 or 34 further including, before said printing step, calendering the partially dried and partially cured printable b-stage resin impregnated paper, to enhance its smoothness for printing.

37. A method of manufacturing a decorative or industrial laminate, characterised by employing one or more b-stage resin impregnated décor papers produced according to any one of claims 33 to 36.

38. A method according to claim 37 including fully curing the b-stage resin impregnated paper(s) in a hot press.

39. A method according to any one of claims 1 to 25 and 33 to 38, including applying a lacquer to the b-stage impregnated paper before pressing in a hot press.

40. A method according to any one of claims 13, 14, 24, 25, 37 and 38, including applying a lacquer to the b-stage impregnated paper surface after pressing in a hot press.

41. A method according to claim 40, including applying a lacquer to one or more surfaces of the laminate including the b-stage paper as the surface layer.

42. A method according to claim 39, 40 or 41, wherein said lacquer contains abrasive resistant particles.

43. A method according to claim 39, 40 or 41, wherein said lacquer contains particles that improve scratch resistance.

44. A method according to claim 30, 40 or 41, wherein said lacquer contains light stabilisers.

45. A method according to claim 39, 40 or 41, wherein said lacquer contains anti-static additives.

46. A method according to claim 39, 40 or 41, wherein said lacquer contains antibacterial additives.

47. Apparatus according to any one of claims 26 to 32 including means to apply a lacquer to the b-stage impregnated paper, b-stage impregnated printed paper, or to a laminate including the b-stage impregnated paper as the surface layer.

48. Apparatus according to claim 47, wherein said lacquer applying mean arranged for applying a lacquer to one or more surfaces of a laminate including the b-stage impregnated paper as the surface layer.

49. A method according to any one of claims 1 to 14 and 33 to 46, wherein said décor paper that is impregnated is a décor print base paper.
